(19) United States
(12) Patent Application Publication
(10) Pub. No.: US 2009/0053602 A1
(43) Pub. Date: Feb. 26, 2009

(54) POSITIVE ELECTRODE FOR NON-AQUEOUS ELECTROLYTE BATTERY AND METHOD OF MANUFACTURING THE SAME, AND NON-AQUEOUS ELECTROLYTE BATTERY AND METHOD OF MANUFACTURING THE SAME

(75) Inventors: Nobuhiro SAKITANI, Moriguchi-shi (JP); Naoki IMACHI, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 12/196,550

(22) Filed: Aug. 22, 2008

(30) Foreign Application Priority Data
Aug. 22, 2007 (JP) 2007-215648

(51) Int. Cl. H01M 4/60; H01M 4/26

(52) U.S. Cl. 429/213; 252/518.1; 29/623.2

(57) ABSTRACT

A method of manufacturing a positive electrode for a non-aqueous electrolyte battery includes: applying a positive electrode slurry onto a positive electrode current collector, the positive electrode slurry containing a positive electrode active material, a conductive agent, carboxymethylcellulose, and a latex-based plastic. The method is characterized by including: a first step of dispersing and mixing the carboxymethylcellulose and the conductive agent in an aqueous solution to prepare a conductive agent slurry; and a second step of dispersing and mixing the positive electrode active material and the latex-based plastic in the conductive agent slurry, to prepare the positive electrode slurry.

### BACKGROUND OF THE INVENTION

1. Field of the Invention

The present invention relates to improvements in positive electrodes used for non-aqueous electrolyte batteries, such as lithium-ion batteries and polymer batteries, and methods of manufacturing the electrodes, as well as the non-aqueous electrolyte batteries and methods of manufacturing the batteries. More particularly, the invention relates to a positive electrode for a non-aqueous electrolyte battery that is excellent in environmental and load characteristics as well as a method of manufacturing the same.

2. Description of Related Art

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, non-aqueous electrolyte batteries that perform charge and discharge by transferring lithium ions between the positive and negative electrodes have been widely used as the driving power source for the mobile information terminal devices. In addition, as hybrid automobiles become more and more popular in the near future, it is expected that an increasing number of non-aqueous electrolyte batteries will go on the market.

Currently, positive electrodes for the non-aqueous electrolyte batteries are produced predominantly in such a manner as described below. Using N-methyl-2-pyrrolidone (NMP) as a solvent, a positive electrode slurry is prepared by mixing a conductive agent such as carbon and a binder such as polyvinylidene fluoride (PVDF) together with the NMP, and the mixture is applied onto a positive electrode current collector (see Japanese Unexamined Patent Publication No. 2001-283831, for example). The positive electrode slurry prepared in accordance with this method, however, tends to shows poor dispersion stability because PVDF has poor affinity with the conductive agent. Consequently, the conductive agent precipitates when the positive electrode slurry is set aside after preparation. Thus, the positive electrode slurry cannot be manufactured and stored in advance, which is disadvantageous in mass production. Moreover, the use of the NMP solvent (organic solvent) results in a greater environmental load and raises concerns for workers' health.

In view of reducing the environmental load and hazardous effects on workers' health, use of water as the solvent for the positive electrode slurry has been studied. Nevertheless, a problem with the use of water as a solvent to prepare a positive electrode slurry is that commonly-used conductive agents tend to undergo secondary aggregation and result in poor dispersion capability since the conductive agents have very small particle sizes (several ten nanometers). In view of this problem, it has been proposed to use a method of performing what is called a “hard-kneading” process (specifically, the process including weighting a positive electrode active material and a conductive agent to predetermined amounts, adding a carboxymethylcellulose solution thereto at several times, and further mixing them together) to promote dispersion of the conductive agent (see Japanese Unexamined Patent Publication No. 2000-348713).

However, when the “hard-kneading” is employed, the following problem arises. Dispersion of the conductive agent is effected by a shearing stress applied by the positive electrode active material to the conductive agent so as to crush the conductive agent. Therefore, when the positive electrode active material has a small particle size, the shearing stress applied to the conductive agent becomes insufficient. Consequently, a desired dispersion effect cannot be obtained. In addition, the “hard-kneading” technique requires viscosity control of the positive electrode slurry (since suitable conditions for the “hard-kneading” need to be found each time a different type of positive electrode active material, conductive agent, or binder is used or each time the composition ratio of them is changed), complicating the preparation of the positive electrode.

Accordingly, it is an object of the present invention to provide a positive electrode for a non-aqueous electrolyte battery and a method of manufacturing the positive electrode as well as a non-aqueous electrolyte battery and a method of manufacturing the battery, in which, even when water is used as the solvent, dispersion effect of the conductive agent can be obtained irrespective of the particle size of the positive electrode active material and at the same time the viscosity control of the positive electrode slurry is not required.

In order to accomplish the foregoing and other objects, the present invention provides a method of manufacturing a positive electrode for a non-aqueous electrolyte battery, comprising: applying a positive electrode slurry onto a positive electrode current collector, the positive electrode slurry containing a positive electrode active material, a conductive agent, carboxymethylcellulose (hereinafter also referred to as “CMC”), and a latex-based plastic, the method further comprising: a first step of dispersing and mixing the CMC and the conductive agent in an aqueous solution to prepare a conductive agent slurry; and a second step of dispersing and mixing the positive electrode active material and the latex-based plastic in the conductive agent slurry, to prepare the positive electrode slurry.

According to the present invention, a significant advantageous effect is exhibited that even when water is used as the solvent, dispersion effect of the conductive agent can be obtained irrespective of the particle size of the positive electrode active material and at the same time the need for the viscosity control of the positive electrode slurry can be eliminated.

### BRIEF DESCRIPTION OF THE DRAWINGS

FIG. 1 is a micrograph illustrating a reflected electron image of a cross section of a positive electrode of Battery A of the invention, and

FIG. 2 is a micrograph illustrating a reflected electron image of a cross section of a positive electrode of Comparative Battery Z1.

### DETAILED DESCRIPTION OF THE INVENTION

According to the present invention, a method of manufacturing a positive electrode for a non-aqueous electrolyte battery comprises applying a positive electrode slurry onto a positive electrode current collector, the positive electrode slurry containing a positive electrode active material, a conductive agent, carboxymethylcellulose, and a latex-based plastic. The method includes a first step of dispersing and mixing the carboxymethylcellulose and the conductive agent in an aqueous solution to prepare a conductive agent slurry, and a second step of dispersing and mixing the positive electrode active material and the latex-based plastic in the conductive agent slurry, to prepare the positive electrode slurry.

By dispersing and mixing the CMC and the conductive agent in the aqueous solution in the first step as in the foregoing, a strong shearing stress can be applied. As a result, the dispersion capability of the conductive agent can be improved. The reason is as follows.

The carbon that is commonly used for the conductive agent at present has a small particle size of several ten nanometers and forms secondary aggregation. For this reason, it is necessary to apply a fairly strong shearing stress to the conductive agent in order to ensure a uniformly dispersed condition. In this case, when the positive electrode active material is kneaded together with the CMC and the conductive agent at the same time, a strong shearing stress is applied also to the positive electrode active material, and the positive electrode active material is consequently pulverized. As a consequence, due to the change in the particle size of the positive electrode active material and the increase of the reaction area, side reactions increase inside the battery. In addition, due to the formation of newly-produced interfaces, it becomes difficult to obtain the electrochemical characteristics that have been expected originally.

In contrast, the method of the present invention is such that the positive electrode active material does not exist in the first step of dispersing and mixing the CMC and the conductive agent, and the positive electrode active material is added to the conductive agent slurry and dispersed and mixed in the slurry in the second step. Thus, no positive electrode active material exists when dispersing the conductive agent (i.e., in the first step), in which a fairly strong shearing stress needs to be applied in order to ensure a uniformly dispersed condition, and the dispersing of the positive electrode active material is performed in the second step, in which it is unnecessary to apply a strong shearing stress. Therefore, the problems associated with the above-described pulverization of the positive electrode active material may be avoided. The reason why it is not necessary to apply a strong shearing stress in the second step is that the positive electrode active material does not undergo secondary aggregation because it has an average particle size of at least about 0.1 μm, which is far greater than the conductive agent.

By dispersing the conductive agent in the CMC in advance in this way, the conductive agent can be dispersed uniformly in the positive electrode active material layer, the conductivity in the positive electrode active material layer can be improved, and moreover, the pulverization of the positive electrode active material can be prevented. Therefore, improvements in the initial charge-discharge efficiency and the high rate discharge are achieved. At the same time, local deterioration can be prevented during the charge-discharge cycles, so the cycle performance is improved.

When using the “hard-kneading” technique, it is difficult to disperse a conductive agent in a positive electrode active material with a small particle size (about 1 μm or less). In the method according to the present invention, however, the conductive agent is dispersed in advance with applying a fairly strong shearing stress in the absence of the positive electrode active material, and therefore, a dispersion effect can be obtained irrespective of the particle size of the positive electrode active material. What is more, the “hard-kneading” technique requires viscosity control of the positive electrode slurry, and suitable conditions for the “hard-kneading” need to be found each time a different type of positive electrode active material, conductive agent, or binder is used or each time the composition ratio of them is changed. In contrast, the method according to the invention makes it possible to prepare a uniformly dispersed positive electrode slurry irrespective of the type of the binder or the composition ratio because the conductive agent is dispersed in the absence of the positive electrode active material.

Furthermore, CMC shows a strong affinity between the [—OH] group and the carbon in the molecule. Therefore, the dispersion stability of the positive electrode slurry becomes high, and precipitation of the solid contents such as carbon does not easily occur. Accordingly, it is possible to prepare and store the positive electrode slurry in advance, leading to good mass productivity. In addition, environmental concerns and health hazard on workers can be lessened since water can be used as the solvent.

It is desirable that, in the first step of dispersing and mixing, the carboxymethylcellulose be dispersed in the aqueous solution and thereafter the conductive agent be added thereto.

When the CMC is dispersed in an aqueous solution and thereafter the conductive agent is added thereto in the dispersing and mixing, the dispersion capability of the conductive agent slurry prepared in the first step is further improved since the CMC is dispersed sufficiently in the aqueous solution at the time of adding the conductive agent.

It is desirable that, in the second step of dispersing and mixing, the positive electrode active material be dispersed and mixed in the conductive agent slurry, and thereafter, the latex-based plastic be added thereto.

When the positive electrode active material is added to the conductive agent slurry and thereafter the latex-based plastic is added thereto in the dispersing and mixing in this way, the shearing stress applied to the positive electrode active material can be lessened more effectively. Therefore, pulverization of the positive electrode active material can be prevented more effectively.

It is desirable that a bead mill method or a roll mill method be used in the first step of dispersing and mixing.

The use of the dispersion method such as a roll mill method and a bead mill method makes mass production possible, resulting in lower manufacturing costs of the positive electrode for a non-aqueous electrolyte battery. The present invention is not limited by these methods, and other methods may be employed, such as those using a three-rod roll mill, a two-rod roll mill, a kneader, a ball mill, a sand mill, an attritor, a vibration mill, a high-speed impeller mixer, a colloid mill, and a Homomixer.

It is desirable that the positive electrode active material have an average particle size of 1 μm or less.

When the average particle size of the positive electrode active material is 1 μm or less, it is difficult to disperse the conductive agent with the use of the said hard-kneading technique. Therefore, the usefulness of the present invention becomes more evident.

It should be noted that the average particle size in the present specification refers to the value determined by a laser diffraction method.

It is desirable that the positive electrode active material be an olivine-type lithium iron phosphate.

Generally, commonly used positive electrode active materials have an average particle size of about 10 μm from the viewpoints of improving the filling density of the positive electrode (the greater the particle size is, the greater the filling density), ensuring the battery performance, and minimizing side reactions (the less the particle size is, the more the side reactions because of the corresponding increase in the surface area). However, since the olivine-type lithium iron phosphate has low electron conductivity, insertion and deinsertion of lithium ions become difficult when the particle size is large. For this reason, the average particle size is kept small to ensure electron conductivity (generally, the average particle size is 1 μm or less, more preferably, in the order of submicrons) when the olivine-type lithium iron phosphate is used. Thus, the method of the present invention makes it possible to ensure the good electron conductivity of the olivine-type lithium iron phosphate and at the same time enhance the dispersion capability of the conductive agent.

It is desirable that the CMC have a degree of etherification of from 0.50 to 1.50, more desirably from 0.65 to 0.75.

The reason why it is desirable that the CMC have a degree of etherification of 1.50 or less (particularly 0.75 or less) is as follows. Although the details are unclear, the smaller the degree of etherification is, the higher the adhesion strength between the positive electrode active material layer and the positive electrode current collector is. When the adhesion between them is improved high in this way, the positive electrode active material layer does not easily peel off in the manufacturing steps subsequent to the preparation of the positive electrode, so the non-aqueous electrolyte battery can be manufactured more easily. The reason why it is preferable that the CMC have a degree of etherification of 0.5 or greater (particularly 0.65 or greater) is that when the degree of etherification is excessively low, the solubility of the CMC to water becomes very poor.

It is desirable that the amount of the CMC be from 0.2 mass % to 1.5 mass % with respect to the total amount of the positive electrode active material, the conductive agent, the CMC, and the latex-based plastic.

The reason is as follows. When the amount of the CMC exceeds 1.5 mass %, a thick film of the CMC forms on the positive electrode active material surface, increasing the plate resistance and degrading the load characteristics. On the other hand, when the amount of the CMC is less than 0.2 mass %, the effect of increasing the viscosity of the positive electrode slurry degrades. As a result, dispersion stability of the positive electrode active material and the conductive agent in the positive electrode slurry and handleability of the positive electrode in manufacturing deteriorate.

It is desirable that the ratio of the mass of the conductive agent to the mass of the CMC be from 5 to 20.

Electric conductivity is different depending the positive electrode active material. When the same level of battery performance as with a positive electrode active material having high conductivity is sought even with a positive electrode active material having a low conductivity, a greater amount of conductive agent needs to be added. In this case, the conductive agent has a relatively large surface area among the substances that constitute the positive electrode active material layer, so when a greater amount of conductive agent is added, it is necessary that a correspondingly greater amount of CMC be added. For these reasons, merely restricting the amounts of the CMC and the conductive agent in the positive electrode active material layer is not enough, and it is desirable to control the ratio of the mass of the conductive agent to the mass of the CMC (hereinafter also referred to as a conductive agent/CMC ratio) as well. As a result of assiduous studies by the present inventors, it has been found desirable to set the conductive agent/CMC ratio to be from 5 to 20, from the viewpoints of improving the above-described electrochemical characteristics and ensuring the dispersion stability of the slurry.

It is desirable that the amount of the latex-based plastic be from 0.5 mass % to 6.0 mass % with respect to the total amount of the positive electrode active material, the conductive agent, the CMC, and the latex-based plastic.

As a result of assiduous studies, the present inventors have found the following. When the amount of the latex-based plastic exceeds 6.0 mass %, the latex-based plastic exists exceedingly around the positive electrode active material, so it hinders migration of lithium ions, degrading the load characteristics. On the other hand, when the amount of the latex-based plastic is less than 0.5 mass %, the strength and flexibility of the positive electrode active material layer become so poor that manufacturing of the battery becomes difficult. Accordingly, it is desirable that the amount of the latex-based plastic be within the foregoing range.

The present invention also provides a method of manufacturing a non-aqueous electrolyte battery, comprising: disposing a positive electrode manufactured according to the above-described method, a negative electrode, and a separator interposed between the positive and negative electrodes, to prepare an electrode assembly; thereafter disposing the electrode assembly in a battery case; filling a non-aqueous electrolyte into the battery case; and thereafter sealing the battery case.

The present invention also provides a positive electrode for a non-aqueous electrolyte secondary battery, comprising: a positive electrode active material layer formed on a surface of a positive electrode current collector, the positive electrode active material layer comprising a positive electrode active material, a conductive agent, carboxymethylcellulose, and a latex-based plastic, wherein the conductive agent is dispersed in the positive electrode active material layer so that the average particle size of the conductive agent is 2 μm or less.

When the conductive agent is dispersed in the positive electrode active material layer so that the average particle size of the conductive agent is 2 μm or less, in other words, when the conductive agent exists in the positive electrode active material layer without forming aggregate (i.e., the conductive agent is uniformly dispersed in the positive electrode active material layer), conductivity of the positive electrode active material layer improves. As a result, the initial charge-discharge efficiency is improved, and the high rate discharge is also improved. At the same time, local deterioration is prevented during charge-discharge cycles, so the cycle performance is improved.

It is desirable that the positive electrode active material have an average particle size of 1 μm or less.

It is desirable that the positive electrode active material be an olivine-type lithium iron phosphate.

It is desirable that the CMC have a degree of etherification of from 0.50 to 1.50, more desirably from 0.65 to 0.75.

It is desirable that the amount of the CMC be from 0.2 mass % to 1.5 mass % with respect to the total amount of the positive electrode active material layer.

It is desirable that the ratio of the mass of the conductive agent to the mass of the CMC be from 5 to 20.

These configurations can exhibit the same advantageous effects as described above.

The present invention also provides a non-aqueous electrolyte battery comprising: an electrode assembly comprising a positive electrode as described above, a negative electrode, and a separator interposed between the positive and negative electrodes; a non-aqueous electrolyte; and a battery case enclosing the non-aqueous electrolyte and the electrode assembly.

### DESCRIPTION OF PREFERRED EMBODIMENTS

Hereinbelow, the present invention is described in further detail based on certain embodiments and examples thereof. It should be construed, however, that the present invention is not limited to the following embodiments and examples, but various changes and modifications are possible without departing from the scope of the invention.

### Preparation of Positive Electrode

First, carboxymethylcellulose [CMC, BSH-12 made by Dai-ichi Kogyo Seiyaku Co., Ltd. (degree of etherification: 0.65 to 0.75)] was dissolved in a deionized water using a mixer (made by Primix Corp. under the trade name “Homomixer”), to obtain a CMC aqueous solution with a concentration of 0.8 mass %. Next, a carbon conductive agent (HS100 made by Denki Kagaku Kogyo Kabushiki Kaisha) was added to the CMC aqueous solution. At this time, the mass ratio of the deionized water, the CMC, and the carbon conductive agent was set at deionized water:CMC:carbon conductive agent=93.6:0.8:5.6. Next, the resultant mixture was kneaded for 30 minutes using a sand mill (made by Asada Tekko Corp., in which the beads were made of zirconia with a diameter of 0.5 mm) at 800 rpm, to obtain a carbon paste.

The resultant carbon paste and an olivine-type lithium iron phosphate (LiFePO₄, average particle size: 500 nm) as the positive electrode active material were kneaded together using a mixer (Robomics made by Primix Corp.). Lastly, styrene-butadiene rubber (SBR) was added thereto and mixed together, to prepare a positive electrode slurry. The olivine-type lithium iron phosphate used was the one in which carbon was superficially coated in an amount of 5 mass % with respect to olivine-type lithium iron phosphate, for the purpose of improving conductivity. The mass ratio of the solid contents was as follows: olivine-type lithium iron phosphate:carbon conductive agent:CMC:SBR=89.5:5.25:0.75:4.5. Finally, the positive electrode slurry was applied onto both sides of a positive electrode current collector made of an aluminum foil, followed by drying and pressure-rolling, whereby a positive electrode was prepared.

### Preparation of Counter Electrode (Reference Electrode)

Metallic lithium was used as the counter electrode.

### Preparation of Non-Aqueous Electrolyte

A lithium salt composed of LiPF₆ was dissolved at a concentration of 1.0 mole/L in a mixed solvent of 3:7 volume ratio of ethylene carbonate (EC) and diethyl carbonate (DEC) to prepare a non-aqueous electrolyte.

### Construction of Single-Electrode Battery

The positive electrode as the working electrode, and metallic lithium as the counter electrode were spirally wound with a polyethylene separator interposed therebetween, and they were put in a glass container. Thereafter, the non-aqueous electrolyte was filled in the glass container, and the container was hermetically sealed, whereby a test battery was fabricated. The resultant battery had a theoretical capacity of 16 mAh.

### Measurement for Degree of Etherification of CMC

The degree of etherification of the CMC used for preparing the positive electrode active material layer and the negative electrode active material layer was determined in the following manner.

First, 0.6 g of sample (anhydride) was wrapped by filter paper, and carbonized in a porcelain crucible. The carbonized sample was cooled and thereafter put in a 500 mL beaker. Then, 250 mL of water and 35 mL of N/10 sulfuric acid were added thereto, followed by boiling for 30 minutes. After cooling the solution, a phenolphthalein indicator was added to the cooled solution, and the excessive acid was back titrated with N/10 potassium hydroxide. From the results, the degree of etherification of the CMC was calculated according to the following equations (1) and (2).

$$A = \frac{af - {bf}^{′}}{Sample anhydride ( g )} - Alkalinity ( or + Acidity ) \qquad Eq . ( 1 )$$

A: amount of N/10 sulfuric acid consumed by the bonded alkali per 1 g of sample (mL)

a: amount of N/10 sulfuric acid consumed (mL)

f: titer of N/10 sulfuric acid

b: titration amount (mL) of N/10 potassium hydroxide

f′: titer of N/10 potassium hydroxide.

$$Degree of etherification = \frac{162 \times A}{10 , 000 - 80 A} \qquad Eq . ( 2 )$$

162: molecular weight of glucose, and

80: molecular weight of CH₂COONa-H.

The alkalinity or the acidity was determined in the following manner.

About 1 g of sample (anhydride) was weighed precisely and put in a 300 mL Erlenmeyer flask, and about 200 mL of water was added thereto to dissolve the sample. Then, 5 mL of N/10 sulfuric acid was added thereto using a pipet, and the solution was boiled for 10 minutes and then cooled. A phenolphthalein indicator was added to the solution, followed by titrating with N/10 potassium hydroxide (S mL). A blank test was conducted at the same time (B mL), and the alkalinity or acidity was calculated according to the following equation (3).

$$Alkalinity = \frac{( B - S ) f}{Sample Anhydride ( g )} \qquad Eq . ( 3 )$$

f: titer of N/10 potassium hydroxide

### EXAMPLES

### Example 1

A battery prepared in the same manner described in the foregoing preferred embodiment was used as Example A1.

The battery fabricated in this manner is hereinafter referred to as Battery A of the invention.

### Comparative Example 1

A battery was fabricated in the same manner as described in Example 1 above, except that the positive electrode slurry was prepared in the following manner.

First, olivine-type lithium iron phosphate (900 g), a conductive agent (52 g), and a CMC solution (170 g) with a concentration of CMC of 0.8 mass % were put in a vessel of a kneader Hivis Mix made by Primix Corp., and the mixture was kneaded at 50 rpm for 60 minutes (hard-kneading). Next, 55 g of the same CMC solution as described above was added thereto, and the mixture was kneaded at 50 rpm for 30 minutes. Thereafter, SBR was put in the vessel and the mixture was further kneaded at 50 rpm for 30 minutes, whereby a positive electrode slurry was prepared. It should be noted that the olivine-type lithium iron phosphate, the conductive agent, the CMC, and the SBR were the same ones as used in Example 1 above.

The battery fabricated in this manner is hereinafter referred to as Comparative Battery Z1.

### Comparative Example 2

A battery was fabricated in the same manner as in Comparative Example 1 above, except lithium cobalt oxide (LiCoO₂, average particle size: 10 μm) was used as the positive electrode active material.

The battery fabricated in this manner is hereinafter referred to as Comparative Battery Z2.

### Experiment 1

The initial charge-discharge efficiency defined by the following equation (1) was determined for each of Battery A and Comparative Batteries Z1 and Z2. The results are shown in Table 1 below.

### Charge-Discharge Conditions

Charge Conditions

Each of the batteries is charged at a constant current of 1.0 It (16 mA) until the battery voltage reaches 4.3 V (vs. Li⁺).

Discharge Conditions

Each of the batteries is discharged at a constant current of 1.0 It (16 mA) until the battery voltage reaches 2.0 V (vs. Li⁺).

Initial charge-discharge efficiency=(Discharge capacity at the first cycle)/(Charge capacity at the first cycle)×100 Eq. (1)

TABLE 1

| | | Comparative | Comparative |
|---|---|---|---|
| | Battery A | Battery Z1 | Battery Z2 |
| Initial | 92.1% | 90.4% | 91.6% |
| charge-discharge | | | |
| efficiency | | | |

As clearly seen from Table 1, the initial charge-discharge efficiency of Battery A of the invention was 92.1%, while the initial charge-discharge efficiency of Comparative Battery Z1 was 90.4%. Thus, Battery A of the invention showed a 1.7% improvement in initial charge-discharge efficiency over Comparative Battery Z1. The reason is believed to be as follows. In Battery A of the invention, the conductive agent is dispersed uniformly in the positive electrode active material layer because the conductive agent has been dispersed in the CMC solution in advance, so the conductivity in the positive electrode is improved. In contrast, in Comparative Battery Z1, the conductive agent is not dispersed uniformly in the positive electrode active material layer because the conductive agent has not been dispersed in the CMC solution in advance, so the conductivity in the positive electrode is lower.

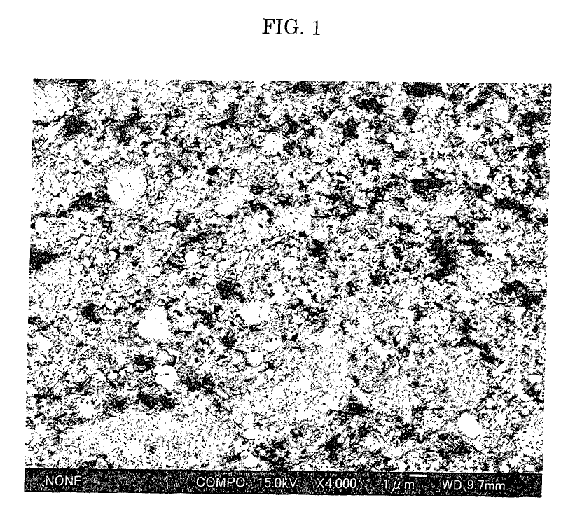

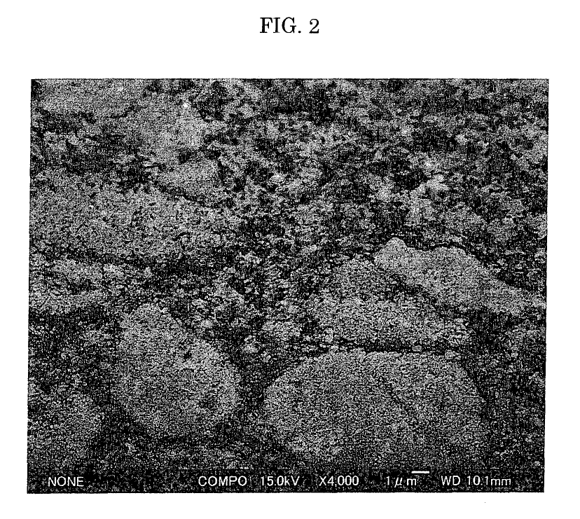

This is detailed with reference to FIGS. 1 and 2. FIG. 1 is a micrograph illustrating a reflected electron image in a cross section of the positive electrode of Battery A of the invention, and FIG. 2 is a micrograph illustrating a reflected electron image in a cross section of the positive electrode of Comparative Battery Z1.

Carbon particles, which serve as the conductive agent, have a high affinity with the binder. The binder is adsorbed around the aggregate of the conductive agent, and the positive electrode active material is adsorbed further onto the binder. As a result, the aggregate with a particle size of 10 μm or greater, in which the positive electrode active material covers the aggregate of the conductive agent, is formed in Comparative Battery Z1, as illustrated in FIG. 2. In contrast, since there exists less aggregate of the conductive agent in Battery A of the invention, Battery A of the invention can prevent the phenomenon in which the binder is adsorbed around the aggregate of the conductive agent and the positive electrode active material is adsorbed further onto the binder. As a result, the aggregate with a large particle size is prevented from being formed, as shown in FIG. 1.

It should be noted that Comparative Battery Z2 shows an initial charge-discharge efficiency of 91.6%, which is 1.2% higher than that of Comparative Battery Z1. The reason is believed to be as follows. The positive electrode active material of Comparative Battery Z2 has a greater particle size than the positive electrode active material of Comparative Battery Z1. Therefore, it is believed that in Comparative Battery Z2, a sufficiently great shearing stress acted on the conductive agent at the time of the hard-kneading, and as a result, the dispersion capability of the conductive agent was improved. However, Battery A of the invention exhibits an even higher initial charge-discharge efficiency than Comparative Battery Z2, which demonstrates the superiority of the present invention.

### Experiment 2

A load test was conducted by charging and discharging each of Battery A and Comparative Batteries Z1 and Z2 under the following charge-discharge conditions. The results are shown in Table 2 below.

Charge Conditions

Each of the batteries is charged at a constant current of 1.0 It (16 mA) to 4.3 V (vs. Li⁺).

Discharge Load Conditions

After charged under the above-described conditions, each of the batteries was discharged at constant currents of 0.2 It (3.2 mA), 1.0 It (16 mA), 2.0 It (32 mA), and 3.0 It (48 mA), to 2.0 V.

TABLE 2

| | Battery A of | Comparative | Comparative |
|---|---|---|---|
| | invention | Battery Z1 | Battery Z2 |
| 0.2 It discharge capacity/ | 100% | 97.6% | 100% |
| theoretical capacity | | | |
| 1.0 It discharge capacity/ | 95.8% | 92.4% | 98.9% |
| theoretical capacity | | | |
| 2.0 It discharge capacity/ | 91.7% | 88.7% | 95.6% |
| theoretical capacity | | | |
| 3.0 It discharge capacity/ | 87.3% | 84.9% | — |
| theoretical capacity | | | |

It is observed that Battery A of the invention exhibited nearly 3% improvements in load characteristics over Comparative Battery Z1 at discharge currents of 0.2 It, 1.0 It, 2.0 It, and 3.0 It.

The reason is believed to be as follows. As already discussed in Experiment 1 above, in Battery A of the invention, the conductive agent is dispersed uniformly in the positive electrode active material layer, so the conductivity in the positive electrode is improved. In contrast, in Comparative Battery Z1, the conductive agent is not dispersed uniformly in the positive electrode active material layer, so the conductivity in the positive electrode is lower.

It is also observed that when a comparison is made between Comparative Batteries Z1 and Z2, Comparative Battery Z2 shows better load characteristics. The reason is believed to be as follows. As discussed in Experiment 1 above, the positive electrode active material of Comparative Battery Z2 has a greater particle size than the positive electrode active material of Comparative Battery Z1. Therefore, in Comparative Battery Z2, it is believed that a greater shearing stress acted on the conductive agent at the time of the hard-kneading, and as a result, the dispersion capability of the conductive agent was improved.

From the results of Experiments 1 and 2, it was found that the initial charge-discharge efficiency and the discharge load characteristics can be improved by dispersing the conductive agent in the CMC solution in advance when preparing the positive electrode slurry. It was also found that a significant advantageous effect is obtained especially when a positive electrode active material having a small particle size (in the case of 1 μm or less).

It should be noted that in Battery A of the invention, the ratio conductive agent/CMC was 13.7, and the ratio 3 It/I It is 87.3% in the battery, as clearly seen from Table 2. Thus, it is demonstrated that Battery A of the invention exhibits excellent load characteristics. The present inventors have found that when the conductive agent/CMC ratio exceeds 20, the dispersion capability of the conductive agent degrades, resulting in poor battery performance, because the amount of CMC is insufficient relative to the amount of the conductive agent. Therefore, it is desirable that the conductive agent/CMC ratio be 20 or less.

### Reference Example 1

In order to investigate the influence of the degree of etherification of CMC on adhesion strength, the following two reference electrodes were prepared, and the adhesion strength of each electrode was studied.

### Reference Example 1-1

First, CMC [BSH-12 made by Dai-ichi Kogyo Seiyaku Co., Ltd. (degree of etherification: 0.65 to 0.75)] was dissolved in a deionized water using a mixer (made by Primix Corp. under the trade name “Homomixer”), to obtain a CMC aqueous solution with a concentration of CMC of 1.0 mass %. Next, a slurry was prepared so that the mass ratio of LiCoO₂ (average particle size: 10 μm), carbon conductive agent (HS100 made by Denki Kagaku Kogyo Kabushiki Kaisha), the just-described CMC, and SBR became LiCoO₂:carbon conductive agent:CMC:SBR=96.9:1.9:0.3:0.9. Using a kneader Hivis Mix made by Primix Corp., the carbon conductive agent was dispersed in the slurry by “hard-kneading,” in which the CMC solution was added at two times. The slurry prepared in this manner was applied onto an aluminum foil, whereby an electrode was prepared.

The electrode prepared in this manner is hereinafter referred to as Reference Electrode s1.

### Reference Example 1-2

An electrode was prepared in the same manner as described in Reference Example 1-1 above, except that CMC 1380 made by Daicel Chemical Industries, Ltd. (degree of etherification: 1.0 to 1.5) was used as the CMC.

The electrode prepared in this manner is hereinafter referred to as Reference Electrode s2.

### Experiment

Adhesion strength was determined for each of the Reference Electrodes s1 and s2. The results are shown in Table 3 below. Specifically, the adhesion strength was determined as follows.

Using tensile and compression strength testers (SV-5 and DRS-5R made by Imada Seisakusho), a 3 cm² circular test piece with an adhesive tape (Scotch Double-coated tape 666 made by 3M Corp.) was pressed against a coated surface of each negative electrode plate and was pulled upward at a constant speed (300 mm/min.), to measure the maximum strength at the time when it peeled off. The number of samples was 5 for each of the electrodes. The mean value of the 5 samples for each electrode is shown in Table 3.

TABLE 3

| | | Adhesion strength |
|---|---|---|
| | | (Adhesion strength of |
| | Type of CMC | Reference electrode s1 |
| | (Degree of etherification) | is taken as 100) |
| Reference | BSH-12, made by Dai-ichi | 100 |
| electrode s1 | Kogyo Seiyaku Co., Ltd. | |
| | (0.65-0.75) | |
| Reference | 1380, made by Daicel | 87 |
| electrode s2 | Chemical Industries, Ltd. | |
| | (1.0-1.5) | |

As clearly seen from Table 3, Reference Electrode s2, which uses the CMC with a degree of etherification of 1.0 to 1.5, shows only 87% of the adhesion strength of Reference Electrode s1, which uses the CMC with a degree of etherification of 0.65 to 0.75. When the adhesion strength is as low as that of Reference Electrode s2, problems may arise in the manufacturing process, such as peeling of the positive electrode active material layer. Accordingly, it will be appreciated that it is preferable to use a CMC having a degree of etherification of from 0.65 to 0.75 as the CMC used in preparing the positive electrode.

### Reference Example 2

In order to investigate the influence of the ratio of CMC and conductive agent on discharge load characteristics, the following three reference batteries were prepared, and the discharge load characteristics of each battery was studied.

### Reference Example 2-1

### Preparation of Positive Electrode

A positive electrode was prepared in the same manner as described in Reference Electrode s1 shown in the Reference Example 1-1.

### Preparation of Negative Electrode

First, CMC [1380 made by Daicel Chemical Industries, Ltd. (degree of etherification: 1.0 to 1.5)] was dissolved in a deionized water using a mixer (made by Primix Corp. under the trade name “Homomixer”), to obtain a CMC aqueous solution with a concentration of 1.0 mass %. Then, 1,000 g of the obtained the CMC aqueous solution and 980 g of artificial graphite (average particle size: 21 μm, surface area: 4.0 m²/g) were weighed, and they were mixed using a mixer (made by Primix Corp. under the trade name of “Hivis Mix”) at 50 rpm for 60 minutes. Next, 500 g of deionized water was added to the mixture to control the viscosity, and the resultant mixture was mixed using the same mixer at 50 rpm for 10 minutes.

Thereafter, 20 g of styrene-butadiene rubber (solid content: 50 mass %, hereafter also referred to as SBR) was added to the mixture and mixed using the same mixer at 30 rpm for 45 minutes, whereby a negative electrode slurry was prepared (the mass ratio of artificial graphite, CMC, and SBR was artificial graphite:CMC:SBR=98.0:1.0:1.0). Subsequently, the resultant negative electrode slurry was applied onto both sides of a negative electrode current collector made of copper, and the resultant material was then dried and pressure-rolled, whereby a negative electrode active material layer was formed on each side of the negative electrode current collector.

Construction of Battery

Respective lead terminals were attached to the positive and negative electrodes, and the positive and negative electrodes were wound in a spiral form with a polyethylene separator interposed therebetween. The wound electrodes were then pressed into a flat shape to obtain a power-generating element, and thereafter, the power-generating element was enclosed into a space made by an aluminum laminate film serving as a battery case. Then, the non-aqueous electrolyte was filled into the space, and thereafter the battery case was sealed by welding the aluminum laminate film, to thus prepare a battery. This battery had a design capacity of 750 mAh.

The battery fabricated in this manner is hereinafter referred to as Reference Battery S1.

### Reference Example 2-2

A battery was fabricated in the same manner as described in Reference Example 2-1 above, except that the positive electrode slurry was prepared so that the mass ratio of LiCoO₂, the conductive agent, the CMC, and the SBR was LiCoO₂:conductive agent CMC:SBR=96.7:1.9:0.5:0.9.

The battery fabricated in this manner is hereinafter referred to as Reference Battery S2.

### Reference Example 2-3

A battery was fabricated in the same manner as described in Reference Example 2-1 above, except that when preparing the positive electrode slurry, NMP was used as the solvent and PVDF was used as the binder in place of the CMC and the SBR, and that a positive electrode was prepared by a hard-kneading process so that the mass ratio of LiCoO₂, the conductive agent, and the PVDF became LiCoO₂:conductive agent:PVDF=95.0:2.5:2.5.

The battery fabricated in this manner is hereinafter referred to as Reference Battery S3.

### Experiment

Reference Batteries S1 through S3 were charged and discharged under the following conditions, to study their discharge load characteristics. The results are shown in Table 4 below.

Charge Conditions

Each of the batteries was charged at a constant current of 1.0 It (750 mA) to 4.2 V and further charged at a constant voltage of 4.2 V to a current of 1/20 It (37.5 mA).

Discharge Conditions

Each of the batteries was discharged at constant currents of 1.0 It (750 mA) and 3.0 It (2250 mA) to 2.75 V.

TABLE 4

| | Ratio of | Discharge capacity ratio |
|---|---|---|
| | conductive agent/CMC | (3.0 It/1.0 It) |
| Reference Battery S1 | 6.3 | 92% |
| Reference Battery S2 | 3.8 | 73% |
| Reference Battery S3 | — | 90% |

Reference Battery S1, in which the conductive agent/CMC ratio is 6.3, showed a ratio of discharge capacity at 3.0 It to discharge capacity at 1.0 It (a discharge capacity ratio) of 92%. On the other hand, Reference Battery S2, in which the conductive agent/CMC ratio is 3.8, showed a lower discharge capacity ratio 73% than Reference Battery S1. The reason is believed to be as follows. When the conductive agent/CMC ratio is too small, the CMC covers around the conductive agent and the plate resistance increases because the amount of the CMC relative to the conductive agent is too large. Thus, it is believed that the discharge load characteristics degrade.

Reference Battery S3, which used a conventional technique and employed NMP as the solvent (i.e., which contained no CMC as the binder), showed a discharge capacity ratio of 90%. The present inventors have found that when the conductive agent/CMC ratio becomes less than 5, the dispersion capability of the conductive agent degrades, resulting in poorer discharge load characteristics than Reference Battery S3, because the amount of CMC is insufficient relative to the amount of the conductive agent. Therefore, it is desirable that the conductive agent/CMC ratio be 5 or greater. From the results of Reference Example 2 and Experiment 2 above, it is desirable that the ratio of conductive agent/CMC be from 5 to 20. It should be noted that when the olivine-type lithium iron phosphate (positive electrode active material) is superficially coated with carbon as in Experiment 2 above, the carbon is also regarded as being included in the conductive agent.

### Other Embodiments

(1) The positive electrode active material is not limited to the above-described LiFePO₄, but various other materials may be used including lithium-containing composite oxides containing cobalt or manganese, such as lithium-containing Co—Ni—Mn composite oxide, lithium-containing Ni—Mn—Al composite oxide, and lithium-containing Ni—Co—Al composite oxide, as well as spinel-type lithium manganese oxides. In addition, although it has been described that SBR is used as a binder, but this is merely illustrative, and various other materials may be employed as long as it does not depart from the scope of the present invention.

(2) Although the foregoing example employs metallic lithium for the counter electrode, it is of course possible to use the negative electrode as described in Reference Example 2 when actually used in a battery. In this case, the negative electrode active material is not limited to artificial graphite as mentioned above. Various other materials may be employed, such as graphite, coke, tin oxides, metallic lithium, silicon, and mixtures thereof, as long as the material is capable of intercalating and deintercalating lithium ions.

(3) The lithium salt in the electrolyte is not limited to LiPF₆, and various other substances may be used, including LiBF₄, LiN(SO₂CF₃)₂, LiN(SO₂C₂F₅)₂, LiPF_{6-X}(CₙF₂ₙ₊₁)_{X} (wherein 1<x<6 and n=1 or 2), which may be used either alone or in combination. The concentration of the lithium salt is not particularly limited, but it is preferable that the concentration of the lithium salt be restricted in the range of from 0.8 moles to 1.5 moles per 1 liter of the electrolyte. The solvents for the electrolyte are not particularly limited to ethylene carbonate (EC) and diethyl carbonate (DEC) mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(4) The present invention may be applied not only to liquid-type batteries but also to gelled polymer batteries. In this case, usable examples of the polymer materials include polyether-based solid polymer, polycarbonate-based solid polymer, polyacrylonitrile-based solid polymer, oxetane-based polymer, epoxy-based polymer, and copolymers or cross-linked polymers comprising two or more of these polymers, as well as PVDF. Any of the above examples of the polymer materials may be used in combination with a lithium salt and an electrolyte, to form a gelled solid electrolyte.

The present invention is suitable for driving power sources for mobile information terminals such as mobile telephones, notebook computers, and PDAs, especially for use in applications that require a high capacity. The invention is also expected to be used for high power applications that require continuous operations under high temperature conditions, such as HEVs and power tools, in which the battery operates under severe operating environments.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A method of manufacturing a positive electrode for a non-aqueous electrolyte battery, comprising:
applying a positive electrode slurry onto a positive electrode current collector, the positive electrode slurry containing a positive electrode active material, a conductive agent, carboxymethylcellulose, and a latex-based plastic, the method further comprising:
a first step of dispersing and mixing the carboxymethylcellulose and the conductive agent in an aqueous solution to prepare a conductive agent slurry; and
a second step of dispersing and mixing the positive electrode active material and the latex-based plastic in the conductive agent slurry, to prepare the positive electrode slurry.

2. The method according to claim 1, wherein, in the first step of dispersing and mixing, the carboxymethylcellulose is dispersed in the aqueous solution and thereafter the conductive agent is added thereto.

3. The method according to claim 1, wherein, in the second step of dispersing and mixing, the positive electrode active material is dispersed and mixed in the conductive agent slurry, and thereafter, the latex-based plastic is added thereto.

4. The method according to claim 1, wherein a bead mill method or a roll mill method is used in the first step of dispersing and mixing.

5. The method according to claim 1, wherein the positive electrode active material has an average particle size of 1 μm or less.

6. The method according to claim 1, wherein the positive electrode active material is an olivine-type lithium iron phosphate.

7. The method according to claim 1, wherein the carboxymethylcellulose has a degree of etherification of from 0.5 to 1.50.

8. The method according to claim 7, wherein the carboxymethylcellulose has a degree of etherification of from 0.65 to 0.75.

9. The method according to claim 1, wherein the amount of the carboxymethylcellulose is from 0.2 mass % to 1.5 mass % with respect to the total amount of the positive electrode active material, the conductive agent, the carboxymethylcellulose, and the latex-based plastic.

10. The method according to claim 1, wherein the ratio of the mass of the conductive agent to the mass of the carboxymethylcellulose is from 5 to 20.

11. The method according to claim 1, wherein the amount of the latex-based plastic is from 0.5 mass % to 6.0 mass % with respect to the total amount of the positive electrode active material, the conductive agent, the carboxymethylcellulose, and the latex-based plastic.

12. A method of manufacturing a non-aqueous electrolyte battery, comprising: disposing a positive electrode manufactured according to the method of claim 1, a negative electrode, and a separator interposed between the positive and negative electrodes, to prepare an electrode assembly; thereafter disposing the electrode assembly in a battery case; filling a non-aqueous electrolyte into the battery case; and thereafter sealing the battery case.

13. A positive electrode for a non-aqueous electrolyte secondary battery, comprising:
a positive electrode active material layer formed on a surface of a positive electrode current collector, the positive electrode active material layer comprising a positive electrode active material, a conductive agent, carboxymethylcellulose, and a latex-based plastic, wherein
the conductive agent is disposed in the positive electrode active material layer so that an average particle size of the conductive agent is 2 μm or less.

14. The positive electrode for a non-aqueous electrolyte battery according to claim 13, wherein the positive electrode active material has an average particle size of 1 μm or less.

15. The positive electrode for a non-aqueous electrolyte battery according to claim 13, wherein the positive electrode active material is an olivine-type lithium iron phosphate.

16. The positive electrode for a non-aqueous electrolyte battery according to claim 13, wherein the carboxymethylcellulose has a degree of etherification of from 0.5 to 1.50.

17. The positive electrode for a non-aqueous electrolyte battery according to claim 16, wherein the carboxymethylcellulose has a degree of etherification of from 0.65 to 0.75.

18. The positive electrode for a non-aqueous electrolyte battery according to claim 13, wherein the amount of the carboxymethylcellulose is from 0.2 mass % to 1.5 mass % with respect to the total amount of the positive electrode active material layer.

19. The positive electrode for a non-aqueous electrolyte battery according to claim 13, wherein the ratio of the mass of the conductive agent to the mass of the carboxymethylcellulose is from 5 to 20.

20. A non-aqueous electrolyte battery comprising: an electrode assembly comprising a positive electrode according to claim 13, a negative electrode, and a separator interposed between the positive and negative electrodes; a non-aqueous electrolyte; and a battery case enclosing the non-aqueous electrolyte and the electrode assembly.
